(19) United States
(12) Patent Application Publication
(10) Pub. No.: US 2004/0147233 A1
(43) Pub. Date: Jul. 29, 2004

(54) Power key assembly fro electronic devices

(76) Inventor: Baojiang Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/391,709

(22) Filed: Mar. 18, 2003

(30) Foreign Application Priority Data
Jan. 29, 2003 (TW) 92201635

(51) Int. Cl. H04Q 7/20

(52) U.S. Cl. 455/90.3

(57) ABSTRACT

The present invention provides a power key assembly for a mobile phone. The power key assembly comprises a front shell (10), a power key (51) and a switch element (52). The front shell (10) includes a face plate (100) and two opposite side walls (103), a top wall (104) and a bottom wall (105) projecting perpendicularly from edges of the face plate. The face plate defines a plurality of openings (102) therein. A collar-like receiving portion (107) is integrally molded in the top wall. The power key is received in the receiving portion. The switch element is arranged on a printed circuit board (PCB) (30) and engages with the power key. A keypad (20) includes a plurality of keys and the keys are received in corresponding openings defined by the face plate. The PCB mechanically engages with said front shell and mechanically and electrically engages with said keypad.

### BACKGROUND OF THE INVENTION

1. Field of the Invention

The present invention relates to power key assemblies usable in electronic devices, such as mobile phones.

2. Related art

Electronic devices need a source of power during operation. Some of them contain batteries which provide power. Most electronic devices need a power switch to switch power on or off as needed. One solution is to combine the function of a power key with another key. For instance, in some mobile phones, the power switch is actuated by pressing the “no” key for a relatively long time. However, this solution has several problems. Such multi-function keys require a more complicated link pattern between the key and the printed circuit board (PCB) in the device. Additionally, keys combining more than one function are used more often than if the same keys are provided separately, which can shorten the life of the key. Moreover, if the key is shielded by a flip cover or similar device, the user must open the cover to actuate the key, which makes operation more inconvenient.

### SUMMARY OF THE INVENTION

An object of the present invention is to provide a power key assembly which has relatively high reliability and which can be operated more conveniently.

To accomplish the above-mentioned objects, the present invention provides a power key assembly for a mobile phone. The power key assembly comprises a front shell, a power key and a switch element. The front shell includes a face plate and two opposite side walls, a top wall and a bottom wall projecting perpendicularly from edges of the face plate. A collar-like receiving portion is integrally molded in the top wall. The power key is received in the receiving portion. The switch element is arranged on a printed circuit board (PCB) and engages with the power key. A keypad includes a plurality of keys and the keys are received in corresponding openings defined through the face plate. The PCB mechanically engages with said front shell and mechanically and electrically engages with said keypad.

Further objects and advantages of the present invention will become more apparent from a consideration of the drawings and the following detailed description.

### BRIEF DESCRIPTION OF THE DRAWINGS

FIG. 1 is an exploded, perspective view of a lower element of a mobile phone having a power key assembly of the present invention;

FIG. 2 is an exploded, perspective view of a power key assembly of the present invention;

FIG. 3 is a perspective view of a power key assembly of the present invention assembled with a keypad and a printed circuit board; and

FIG. 4 is similar to FIG. 3, but viewed from another aspect.

### DETAILED DESCRIPTION OF THE PREFERRED EMBODIMENT

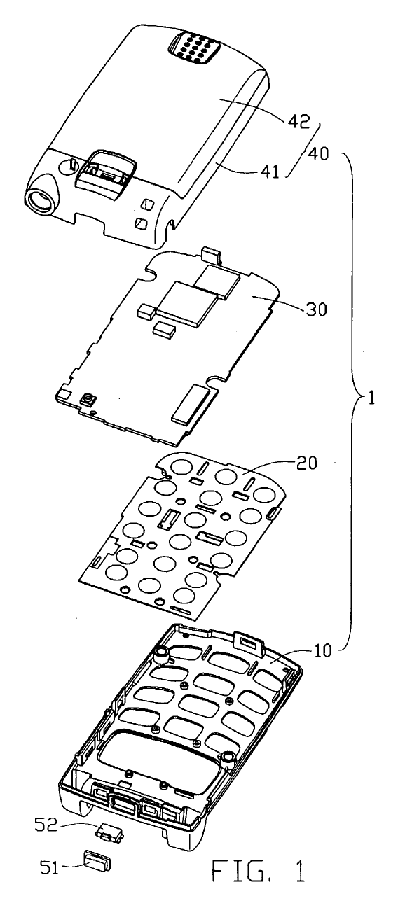

A power key assembly in accordance with the present invention is installed in an electronic device. In the embodiment shown in FIG. 1, the electronic device is a lower element 1 of a foldable mobile phone. The lower element 1 includes a front shell 10, a keypad 20, a printed circuit board (PCB) 30, and a back shell 40, which includes a back cover 41 and a battery cover 42. The power key assembly comprises a power key 51, a switch element 52, and the front shell 10 of the mobile phone.

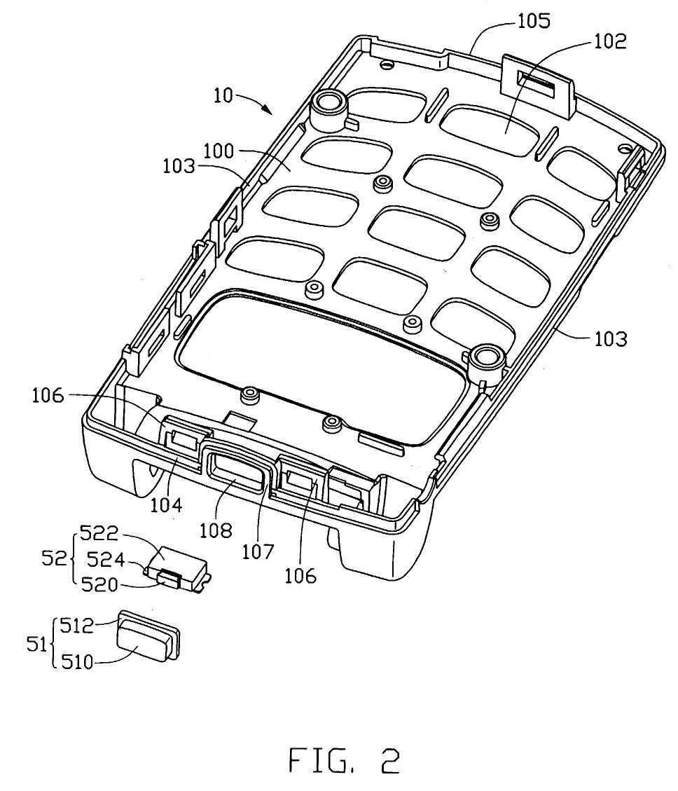

Referring to FIG. 2, the front shell 10 includes a substantially rectangular face plate 100 defining a plurality of openings 102 therethrough and forming two opposite side walls 103, a top wall 104 and a bottom wall 105 perpendicularly projecting from the face plate 100. The face plate 100 and the walls 103, 104, 105 cooperatively define a space wherein the keypad 20 can be mounted. The openings 102 are a little larger than corresponding keys (not shown) located on the keypad 20, for receiving the keys therein. A plurality of clasps 106 are formed on walls 103, 104, 105 for engaging with the PCB 30 and the back cover 41. In particular, a pair of clasps 106 are disposed on the top wall 104 and a receiving portion 107 is formed between the pair of clasps 106, integrally molded in the top wall 104. The receiving portion 107 defines a through hole 108 therein.

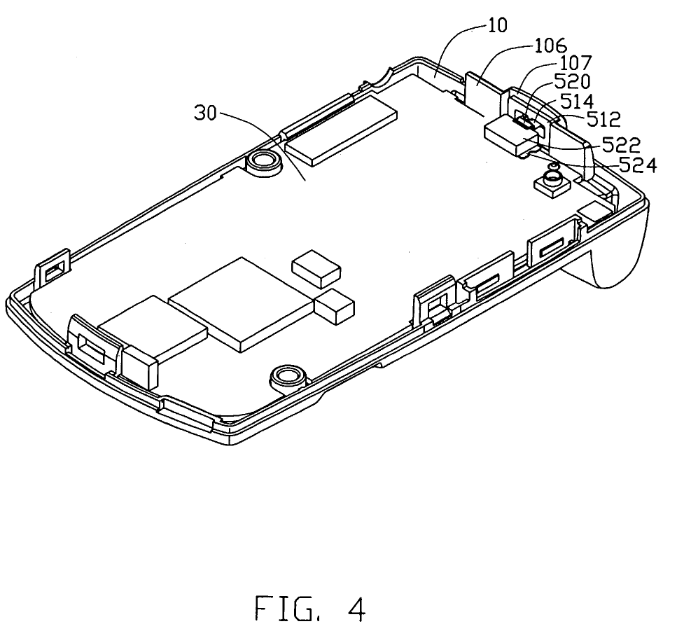

The power key 51 has a base portion 512, a press portion 510 extending from the base portion 512, and a resisting portion 514 (see FIG. 4) extending through the base portion 512 from the press portion 510. The base portion 512 is hollow in structure. An exterior diameter of the base portion 512 is larger than a diameter of the through hole 108. The press portion 510 is correspondingly smaller than that of the through hole 108 of the receiving portion 107, whereby the press portion 510 can be received in the through hole 108. The switch element 52 is attachable to the PCB 30 such that, in assembly it is adjacent to the top wall 104 of the front shell 10. The switch element 52 includes a main portion 522, an elastic portion 520 movably engaged in the main portion 522, and a solder portion 524 for soldering the switch element 52 onto the PCB 30. The main portion 522 encloses certain circuits communicating with power switch circuits (not shown) on the PCB 30, which can switch a power connection on or off. Note that most of the functional components are omitted on the PCB 30 for simplicity.

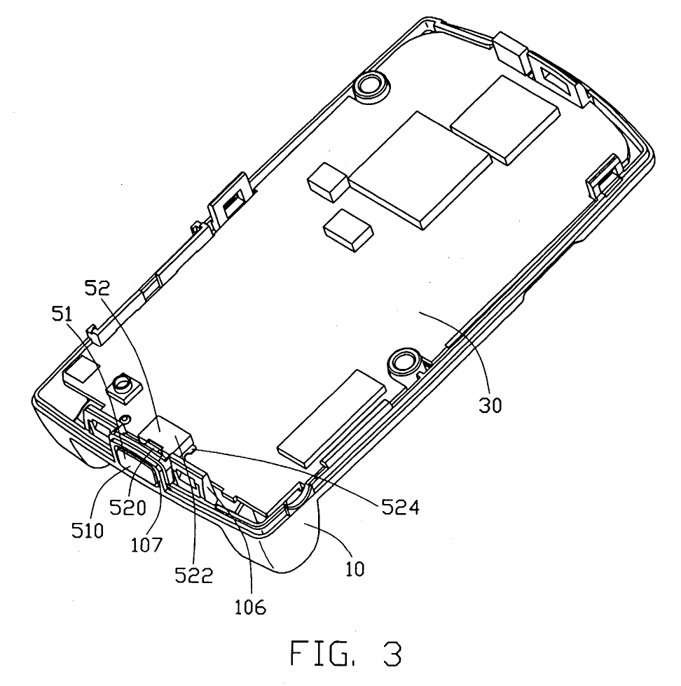

Referring to FIGS. 3 and 4, in assembly, the keypad 20 is mounted to the front shell 10. Keys on the keypad 20 are received in corresponding openings 102 defined in the front shell 10. The power key 51 is movably engaged with the front shell 10, with the press portion 510 being received in the through hole 108 and the base portion 512 firmly abutting against the receiving portion 107. In a non-depressed state, the press portion 510 protrudes out of the through hole 108 for users to press. The PCB 30 with the switch element 52 soldered thereon mechanically engages with the front shell 10 and mechanically and electrically engages with the keypad 20. The elastic portion 520 of the switch element 52 engages with the resisting portion 514 of the power key 51. The back cover 41 snappingly engages with the front shell 10, and the battery cover 42 is received in the back cover 41.

In operation, to connect power to the lower element 1, a user presses the press portion 510 of the power key 51. The press portion 510 moves inwardly, pushing the resisting portion 514 against the elastic portion 520 of the switch element 52. The elastic portion 520 thus moves inwardly to make connections between certain circuits (not shown) arranged in the main portion 522. Since such circuits electrically connect with power switch circuits (not shown) arranged on the PCB 30, a power connection is created. A battery inside the battery cover 42 is thereby connected to provide power to the lower element 1. To disconnect the power connection, the user presses the press portion 510 of the power key 51 again. The elastic portion 520 of the switch element 52 is forced to return its original position, thereby switching off the power connection. The battery then stops providing power to the lower element 1.

The power key assembly in accordance with the present invention has better reliability since the receiving portion 107 is integrally molded in the top wall 104 of the front shell 10 rather than being separately assembled with the top wall 104. This integration ensures that the receiving portion 107 is not prone to be deformed during assembly. In addition, when this power key assembly is used in an electronic device, such as a foldable mobile phone, the user can turn the phone on or off without opening the cover thereof, thereby increasing the convenience of use. Furthermore, the power key 51 and the switch element 52 can be firmly assembled with the front shell 10, the keypad 20 and the PCB 30, providing a firmly integrated subassembly which facilitates production assembly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A power key assembly usable in electronic devices, comprising:
a front shell, including a face plate and at least one wall projecting at an angle from at least one edge of the face plate, and a receiving portion being integrally molded with the at least one wall;
a power key received in said receiving portion; and
a switch element engaging with said power key.

2. The power key assembly as claimed in claim 1, wherein said front shell is a key panel for a mobile phone.

3. The power key assembly as claimed in claim 1, wherein said front shell, in addition to said face plate, includes two opposite side walls, a top wall and a bottom wall.

4. The power key assembly as claimed in claim 3, wherein said receiving portion is integrally molded in said top wall.

5. The power key assembly as claimed in claim 1, wherein said power key includes a base portion, a press portion extending from said base portion, and a resisting portion extending beyond said base portion from said press portion.

6. The power key assembly as claimed in claim 5, wherein said receiving portion defines a through hole in which said press portion is received.

7. The power key assembly as claimed in claim 1, wherein said switch element is arranged on a printed circuit board.

8. The power key assembly as claimed in claim 1, wherein said switch element includes a main portion, an elastic portion and a solder portion.

9. The power key assembly as claimed in claim 8, wherein said elastic portion engages with said power key.

10. A power key assembly usable in electronic devices, comprising:
a front shell, including a face plate and at least one wall projecting at an angle from at least one edge of the face plate, said face plate defining a plurality of openings therein, and a receiving portion being integrally molded in one of the at least one walls;
a power key received in said receiving portion;
a keypad including a plurality of keys, said keys being received in corresponding openings defined in said face plate;
a printed circuit board (PCB) mechanically engaging with said front shell, and the PCB mechanically and electrically engaging with said keypad; and
a switch element being arranged on said PCB and engaging with said power key.

11. A power key assembly comprising:
an enclosure including a front plate defining a plurality of key receiving openings for receiving a plurality of number keys therein, and a circumferential wall located on a periphery of said front plate;
a through hole defined in said circumferential wall,
said through hole and said key receiving openings being defined along different directions perpendicular to each other,
a printed circuit board disposed in said shell under said front plate and surrounded by said circumferential wall, said printed circuit board being arranged in parallel to said front face;
a switch located on an edge region of the printed circuit board and close to said through hole; and
a discrete power key defining a front end extending through the through hole and a rear end locate around and engagable with the switch.

12. The assembly as claimed in claim 11, wherein said shell includes upper and lower halves, said upper half being integrally formed with the front plate and defining a receiving portion with the through hole therein.

13. The assembly as claimed in claim 12, wherein at least one clasp used for fastening to the lower half, is positioned closely beside said receiving portion so as to enhance rigidity around the receiving portion.

14. The assembly as claimed in claim 11, wherein said circumferential wall includes a short side and a long side, said power key being located on the short side far away from an area the key receiving openings are located at so as to prevent a user from inadvertently pushing the power key during operation of the number keys.
